(19) United States
(12) Patent Application Publication
(10) Pub. No.: US 2002/0165720 A1
(43) Pub. Date: Nov. 7, 2002

(54) Methods and system for encoding and decoding a media sequence

(76) Inventors: Timothy M. Johnson, Algonquin, IL (US); Ziqiang Qian, Barrington, IL (US)

Correspondence Address: FRANK C. NICHOLAS, CARDINAL LAW GROUP, Sutie 2000, 1603 Orrington Avenue, Evanston, IL, 60201, US

(21) Appl. No.: 09/798,794

(22) Filed: Mar. 2, 2001

(51) Int. Cl. G10L 21/00

(52) U.S. Cl. 704/500

(57) ABSTRACT

A method of encoding a media sequence with at least one applet object provided. The applet object is inserted into at least one FMO file. A media sequence is provided with a media file. The FMO file is integrated into the media file and a synchronous bit is inserted.

A further method encompasses decoding a media sequence.

### RELATED APPLICATION DATA

This application claims priority to U.S. patent application Ser. No. 09/507,084, entitled “METHOD AND SYSTEM FOR ENCODING AN AUDIO SEQUENCE WITH SYNCHRONIZED DATA AND OUTPUTTING THE SAME,” filed Feb. 18, 2000, the entire disclosure of which is incorporated herein by reference.

### FIELD OF THE INVENTION

In general, the invention relates to the field of digital audio recording. More specifically, the invention relates to audio sequences within a digital audio recording and in particular, to the encoding and decoding of synchronized data within an audio sequence.

### BACKGROUND OF THE INVENTION

With the rise in popularity of karaoke as an entertainment means, more and more songs are put in karaoke format. As a result, the need to transport and store these ever-growing musical libraries has become paramount. In some instances, digitized data representing the music and the lyrics has been compressed using standard digital compression techniques. For example, one popular current digital compression technique employs the standard compression algorithm known as Musical Instrument Digital Interface (MIDI). U.S. Pat. No. 5,648,628 discloses a device that combines music and lyrics for the purpose of karaoke. The device in the '628 patent uses the standard MIDI format with a changeable cartridge which stores the MIDI files. MIDI compatible devices however, require a physical size deemed obese by the consumer demand for smaller hand held devices.

In order to compensate for consumer preferences, smaller digital music players using the MP3 compression standard have been produced with built in displays to provide the audio, text, and graphics needed for Karaoke. These devices have become even more popular with the availability of hundreds of thousands of song titles now in the MP3 format. With such a consumer demand, large numbers of portable digital music players have become available, with even more soon to be released to the consumer market. Although these portable digital music players share one common feature, the ability to play audio of various formats, they are virtually non-compatible with each other because most have proprietary interfaces, custom operating systems (OS), and non-standard display systems.

As the relatively new portable digital music player market becomes increasingly competitive, companies will struggle to find novel features in an effort to obtain or maintain differentiation among each others products. In addition, as devices such as personal data assistants (PDA's) and cellular telephones begin to integrate digital audio technology, makers of portable digital media players will be forced to adopt technologies and features associated with products in those markets. The line between general-purpose PDA's, cellular telephones, and media players will soon become increasingly blurred for some market segments.

Interoperability among these various devices however can only be possible with the definition and adoption of standards. Currently, there is no unified means of distributing non-audio, interactive content to and from portable music players. Without a unified means or “standard” for providing non-audio data, innovation among manufacturers of general-purpose PDA's, cellular telephones, and media players will stagnate.

Therefore, it would be desirable to have a method and system for encoding and decoding interactive text, graphics, and sound in a manor that improves upon the above-mentioned situations and prior art. Ideally, such a technology would be adaptable for consumer devises utilizing varying compression standards, file formats, and CODECs as are known in the art.

### BRIEF DESCRIPTION OF THE DRAWINGS

FIG. 1 is a block diagram illustrating an MP3 bit stream and its components as described in the MP3 specification standard and in accordance with the present invention;

FIG. 2 is a block diagram of a data frame structure within the MP3 bit stream of FIG. 1, in accordance with the present invention;

FIG. 3 is a block diagram of a data chunk component within the data frame structure of FIG. 2, in accordance with the present invention;

FIG. 4 is a block diagram of object mode code syntax for one embodiment of the data chunk component of FIG. 3, in accordance with the present invention; and

FIG. 5 is a block diagram of the bit position and identification of object flags, in accordance with the present invention.

### DETAILED DESCRIPTION OF A PREFERRED EMBODIMENT

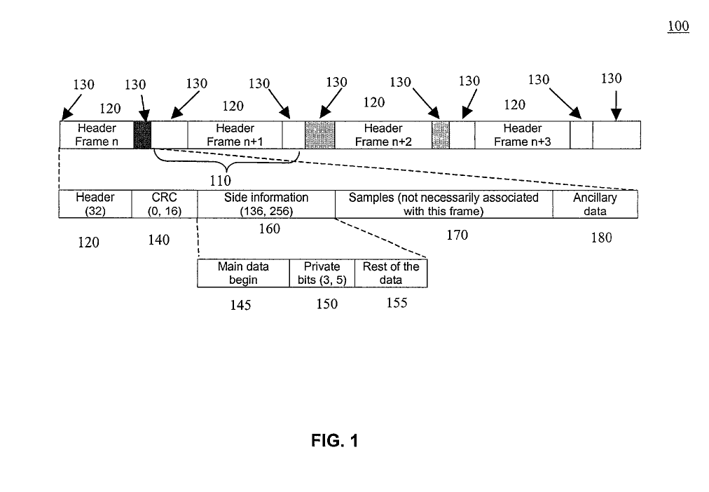

Illustrated in FIG. 1, an MP3 file (bit stream) and its components 100 are associated with one embodiment of the invention. Alternative embodiments may use any media file containing unused bit portions. A media file may be defined as any file containing audio, video, graphics, or text; or promotes user interactivity. An MP3 file can be built up from a succession of small parts called frames 110. A frame 110 may be comprised of a data block and the data blocks header 120 and audio information 130. MP3 frames 110 are organized in the manner illustrated in FIG. 1, where the header 120 consists of 32 bits, and the CRC (Cyclic Redundancy Code) 140 may have either 0 or 16 bits depending on if error detection has been applied to the bit stream 100. Side information 160 can occupy 136 bits for a single channel frame or 256 bits for a dual channel frame. The side information 160 can be divided into a main data begin 145, private bits 150, and rest of the data 155 segments. Samples 170 known in the art to contain Huffman coded audio signals, along with ancillary data 180, may use the rest of the available frame 110 bits. In MP3 files 100, frames 110 are often dependent of each other due to the possible use of a “bit reservoir”, which is a kind of buffer known in the art.

The size of a complete frame 110 can be calculated from its bit rate, sampling rate and padding status, which is defined in the header 120. The formula for computing frame size is

$$FrameSize = \{ \begin{matrix}144 \times BitRate / SamplingRate & if the padding bit is cleared \\ 144 \times BitRate / SamplingRate + 1 & if the padding bit is set\end{matrix}$$

where the unit for FrameSize is byte. For example, to compress a stereo audio with 44.1 kHz sampling rate to bit rate 128 kbit/s, the FrameSize can be either 417 or 418 byte, depending on the padding bit. The size of both samples 170 and ancillary data 180 may be determined from the header 120 and side information 160.

For one embodiment of the invention, synchronized lyrics or text and control information, which can be displayed or invoked while playing a karaoke style MP3 file, needs to be embedded within the MP3 file. A simple way to embed the data is to use the ancillary data 180 component of a frame 110 but alternative embodiments may use different data locations. By reserving 16-bits from each ancillary data component 180 within the MP3 frames 110 for embedded data, a new file named MP3K can be generated from the regular MP3 file, without changing the MP3 bit stream 100 standard. The MP3K file is generic media file name and may be used with embodiments of any media format or standard processed by an embodiment of the invention. One embodiment of the invention provides that the complete media and data information be contained in a bit stream called a media sequence, which may consist of one or more media files.

Another embodiment of the invention may use an object-oriented design approach to organize the embedded data within the ancillary data 180 components. An object-oriented design can simplify the updating, structure, and maintenance of embedded data.

An object can be a subset of predefined functions and data. In one embodiment of the invention, lyrics or text, system control, and display information, may be encapsulated by objects. Another embodiment of the invention may define the structure of the objects (MP3K Objects) as shown below, however alternative embodiments may use different structures.

$$Object \{ \begin{matrix}Group Number , GN ( 32 ) \\ Number of Functions ( 8 ) \\ Obect Flags , OF ( 16 ) \\ Data Structure Array \\ Function Pointer Array\end{matrix}$$

Each object can be uniquely identified by a 32-bit group number (GN). The number of functions defined by an object can be specified in the header 120. A further embodiment of the invention provides for the registration of objects, as they are loaded into a processing device (MP3 player, PC computer, cell phone, or other embodiment). During registration, a table can be constructed with the entry point of the objects in memory so that when referenced, each object can be found easily. The processing devices for this embodiment of the invention, typically consist of a player and player programs, such as are found in a MP3 player. Alternative compression-oriented audio processing devices or media programs capable of processing the MP3K (or alternative format) data may be used. Additionally, an encoded media sequence may be transferred to a device medium. A device medium may include, but is not limited to, wireless transmission, compact disc, network databases, and static memory.

The objects may also have constructor and destructor functions known in the art, which can be used to initialize certain object parameters. Constructors can be invoked during the object registration or upon the objects first invocation, such as the initial play of a MP3K file within an MP3 player. Destructors can be invoked during system shutdown or when the playback of a MP3K file is stopped. In addition to constructors and destructors, objects can be invoked by passing messages to the object's system message handler. Alternative embodiments of invoking objects may also be used.

In one embodiment, the objects flags (OF) field within the object header can define when the object constructors and destructors should be invoked, as illustrated in the following table.

Object Flags (16)

| | | | | | | | | | | | | | | | |
|---|---|---|---|---|---|---|---|---|---|---|---|---|---|---|---|
| Res | Res | Res | Res | Res | Res | Res | Res | Res | Res | Res | Res | Res | Res | Res | Res |

| | |
|---|---|
| LD | When set, the constructor of the object will be run when the object is loaded. |
| CALL | When set, the constructor of the object will be run when the object is first invoked. |
| ULD | When set, the destructor of the object will be called when the system shuts down. |
| STP | When set, the destructor of the object will be called when the file that initially invoked the object |
| | stops |

In alternative embodiments however, these constructor and destructor parameters may be defined in different locations.

Functions referenced by an object can be classified by their functionalities. One embodiment of the invention manages different sets of functions by their class. In an alternative and preferred embodiment, a defined function may provide its parameter numbers, lengths, and default values (if any) of each parameter, to use for classification. In addition, function flags need to be set. Both class and function structures are shown below.

$$\begin{matrix}Class & \{ \begin{matrix}Class Number ( 8 ) \\ Number of Functions ( 8 ) \\ Function Pointer Array\end{matrix} \\ Function & \{ \begin{matrix}Function Number ( 8 ) \\ Number of Parameters ( 8 ) \\ Function Flags , FF ( 8 ) \\ Function Types , FT ( 8 ) \\ Parameters Pointer Array\end{matrix}\end{matrix}$$

Class Number and Function Number may be combined to generate a function ID. Parameter information can be stored in a parameter structure, in which both length and default value can be given as:

$$Parameters \{ \begin{matrix}Length ( 8 ) \\ Value ( 32 )\end{matrix}$$

In one embodiment of the invention, an object can be delivered by a separate file called an attribute file, suffixed by “.fmo” in one embodiment, or may alternately be delivered by concatenating a FMO formatted file at the end of a media file. FMO formatted files are comprised of one or more applet objects and the applet objects corresponding data objects. Essentially, FMO formatted files (FMO files) are a transport mechanism for the applet and data objects. The applet and data objects may contain, but are not limited to, object definition, lyrics/text contents, performer descriptions, general data and variables, and multimedia data.

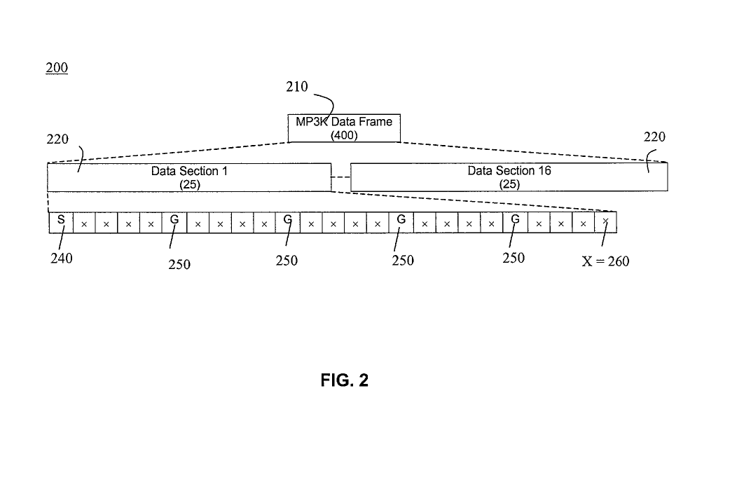

As previously mentioned, a MP3K file can be generated from a MP3 file by embedding data within the MP3 file. FIG. 2 illustrates a data frame structure 200 for a MP3K data frame 210 constructed from MP3 (or similar type) files. MP3K bit streams (encoded media sequences) may be composed of MP3K data frames 210, which can contain a sync word (SW), a group number (GN), and data chunk(s).

A MP3K data frame 210 may consist of 400 bits which, for a MP3K file formatted with 16-bits of ancillary data 180, is 25 MP3 frames 110. One embodiment of a MP3K data frame 210 is defined as 400 bits since the synchronization word will be included once, and the group number will be repeated exactly twice. A preferred embodiment of the invention provides MP3 formatted files with 16-bits of ancillary data 180 however, the number of ancillary data bits may be completely arbitrary. A physical limit to the minimum number of bits that must be reserved in the ancillary data section 180 of an encoded bit stream will be dependent on the functionality to be implemented and the type of CODEC used as is known in the art.

In another embodiment of FIG. 2, one MP3K frame can be divided into 16 sections (data sections) 220. In each section, one bit of synchronization word 240, defined as 0xFF00, may be embedded. The purpose of the synchronization word 240 is to facilitate locating the beginning of the group number 250. This can be especially critical and difficult when trying to decode a MP3K bit stream in a streaming environment in which frames can be dropped. The bit of synchronization word (denoted S) 240 can be located in the first bit position of each section 220. GN can take 32 bits, which are also diversified in data sections 220. Four GN bits (denoted G) 250 are stored in each section 220 (one for every five bits except for the first bit). Subsequently, a GN will be repeated for every eight sections. Both SW 240 and GN 250 bits are allocated in an order of significance, meaning significant bits will be stored first. The spaces marked by x 260 between S 240 and G 250, or two adjacent Gs 250 are used for data storage.

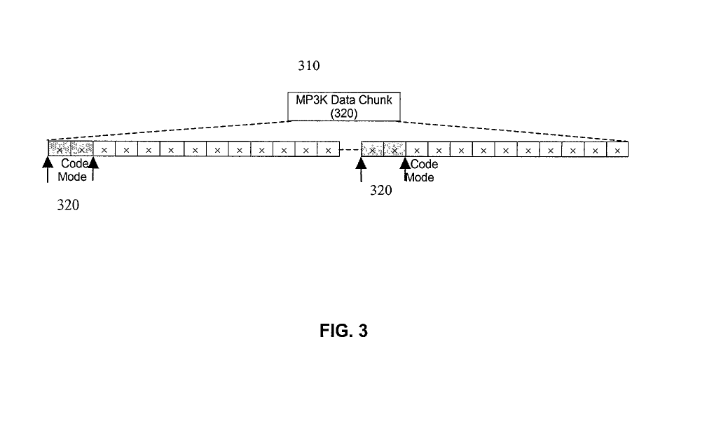

The total space for data storage in the embodiment of FIG. 2 is 320 bits, and can be called a data chunk, as is illustrated in FIG. 3 as 310. Synchronized data can be coded (data code) by both prefix codes and object dependent codebooks. A prefix code takes two bits and defines code modes (data modes) 320 of the data code while a codebook specifies object functions. The following table describes one embodiment of prefix code.

| Mode | Name | Description |
|---|---|---|
| 00 | NOP | No operation |
| 01 | Object | An object |
| 10-11 | Reserved | |

According to the above table, there are two different code modes 320, “NOP” (00) and “Object” (01). “NOP” tells an MP3K decoder that there is no operation while “Object” offers some specific information about object functions.

In one embodiment of the invention, a codebook is generated based on the content and/or pre-designed object associated with a particular MP3K file. The object may not be the same for different MP3K files therefore no data code 320 is allowed to cross data chunk 310 borders.

In another embodiment of the invention, a variable length code containing detailed object information may be passed from an MP3K file to the processing device, when an object mode is detected. The information may include number of functions, function indices, and parameter status with values (if any). If a new parameter value (instead of a default value) needs to be specified, the 1-bit parameter status will be set to “1”and a new parameter value will follow, otherwise the parameter status is set to “0”. When a functions parameter values are fixed, no status bits or parameter values need to be passed. The code length for number of functions and function indices can be determined from the attribute file. After a function index is given, the functions parameter number and the bit length of each parameter can be found from the associated function definition.

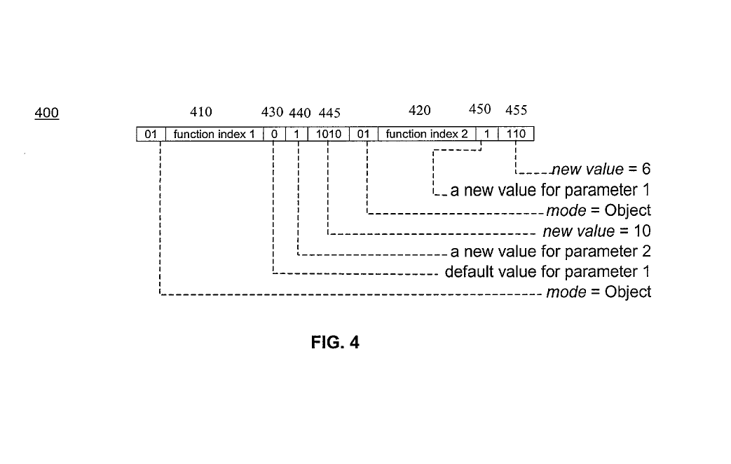

FIG. 4 illustrates one embodiment of object mode code syntax 400. In this embodiment, it is assumed that two functions are involved in a data frame. Function one 410 has two parameters, in which parameter one 430 may take a default value, and parameter two 440 may use a new value 445. Function two 420 has one parameter 450, which uses a new value 455. For this embodiment, it is further assumed that when a new parameter value is specified, it may be only valid for the current MP3K frame. Its default value may not change.

The previously mentioned attribute file provides data and other information, which includes object definition, lyrics, text contents, performer descriptions, general data and variables and multimedia data. The FMO files are comprised of one or more applet objects and the corresponding data objects. These objects should be managed as to facilitate the compilation of objects, based on invocation by other objects and media files, for transfer to the processing device. There are essentially three ways FMO files can be distributed; encapsulated within a media file within an ID3 tag, provided in bulk, or placed at the beginning of a media file.

For one embodiment of the invention, encapsulating FMO files within a media file within an ID3 tag is the best method for streaming applications. The embodiment uses this method when one applet object and the associated data object are included in the FMO file. ID3 and ID3 tag is in reference to the ID3 compression standard.

The providing in bulk method referrers to providing applet and data objects in “bulk”. That is, a library of objects can be provided for download in a single FMO file. These objects can be loaded and paired with the appropriate media file as necessary.

The final method can be for systems in which ID3 is not supported. In this method, FMO files may be placed at the beginning of a media file. Since the latter two methods are relatively straightforward to individuals skilled in the art, only the first method of embedding FMO in ID3 will be discussed in detail.

It is clear that ID3 has become a popular standard for embedding useful, non-audio content, within an encoded audio file. On embodiment of the invention provides the ID3 standard with a method enabling much more functionality for ID3. The method includes embedding FMO files within ID3.

An ID3 tag may be comprised of several frames. Each frame begins with a header, which can be followed by some payload data. ID3 has provisions for embedding private data within a frame of an ID3 tag. The frame identifier is the character set “PRIV” in the ASCII standard. The frame length can be the length, in bytes, of the entire FMO file. All frames can have the format illustrated in the following table.

| Byte Number | Description |
|---|---|
| 1 | Frame identifier. For embedding FMO |
| 2 | data, this identifier should be “PRIV” in ASCII |
| 3 | (0 × 50, 0 × 52, 0 × 49, 0 × 56) |
| 4 | |
| 5 | Size in bytes, most significant byte first |
| 6 | |
| 7 | Size, least significant byte. |
| 8 | |
| 9 | Flags, Byte 1 |
| 10 | Flags, Byte 2 |

One embodiment of the invention provides that in the frame header, the size descriptor is followed by two flags bytes with all unused flags cleared. The first byte can be for status messages, and the second byte can be for encoding purposes. If an unknown flag is set in the first byte, the frame may not be changed without the bit cleared. If an unknown flag is set in the second byte, it is likely to not be readable. The following table illustrates the ID3 flags. The preferred flag settings for the invention are described in the paragraphs following.

ID3 Flags Byte No. 1

| | | | | | | | |
|---|---|---|---|---|---|---|---|
| 7 | 6 | 5 | 4 | 3 | 2 | 1 | 0 |
| a | b | c | 0 | 0 | 0 | 0 | 0 |

ID3 Flags Byte No. 2

| | | | | | | | |
|---|---|---|---|---|---|---|---|
| 7 | 6 | 5 | 4 | 3 | 2 | 1 | 0 |
| i | j | k | 0 | 0 | 0 | 0 | 0 |

The tag alter preservation flag (“a” for ID3 flags byte no. 1), indicates to the software what should be done with a frame if it is unknown and the tag is altered in any way. This may apply to all kinds of alterations, including, but not limited to, adding more padding and reordering the frames. This bit should always be zero for embedding a FMO file, indicating the frame should be preserved. A 1 would indicate the frame should be discarded.

The file alter preservation flag (“b” for ID3 flags byte no. 1), tells the software what to do with this frame if it is unknown and the file, excluding the tag is altered. This does not apply when the audio is completely replaced with other audio data. For one embodiment of the invention, this bit should always be zero for embedding an FMO file; again indicating the file should be preserved and not discarded.

When set, the read only flag (“c” for ID3 flags byte no. 1), tells the software that the contents of this frame is intended to be read only and that changing the contents might break something (e.g. a signature). If the contents are changed, without knowledge in why the frame was flagged read only and without taking the proper means to compensate (e.g. recalculating the signature), the bit should be cleared. All FMO files should be read-only therefore; this bit should be set to one.

The frame compression flag (“i” for ID3 flags byte no. 2), indicates whether the frame is compressed. This bit should be 0 for FMO files, meaning frame is not compressed.

The encryption flag (“j” for ID3 flags byte no. 2) indicates whether the frame is encrypted. One embodiment of the invention has its own form of encryption/authentication therefore; this bit should always be zero indicating the frame is not encrypted.

Last, the grouping identity flag (“k” for ID3 flags byte no. 2) indicates whether this frame belongs in a group with other frames. If set, a group identifier byte is added to the frame header and every frame with the same group identifier belongs to the same group. This bit should always be clear when embedding an FMO file, again to indicate the frame is not encrypted.

One embodiment of the invention provides that the first 16-bits of an FMO file contains the version number of the format included in the FMO file. Each nybble (half a byte) is interpreted as a BCD (binary coded decimal) number. The full version is represented by a number xx.nn, where xx is the upper most significant 16-bits and nn, the lower.

Unlike the version number for the FMO file format, the version number for the object can be interpreted as the version of that object only, and not the format. The library software responsible for managing objects may use this field to purge older objects as needed. The smallest size for any type of data in an FMO file is 8-bits. For larger data sizes, the most significant byte is included first, followed by all lesser significant bytes.

In another embodiment of the invention, every FMO file may define more than just one object. This may simplify the distribution and management of these objects. To handle multiple objects, the next word in the FMO file should be interpreted as the number of objects defined within the file. This embodiment does not recognize the value of zero and it should not be used. Further, for each object there can be a 32-bit pointer to that object within the FMO file.

Within the FMO file, all objects begin with a header. The object header may contain information regarding the format, identifier and version of the object. For one embodiment, the object identifier may be a unique 32-bit number used to identify the object and is assigned and tracked by a central authority. This method can help ensure trouble-free communication between objects.

A 16-bit version number may be provided in the object header to help identify various versions of objects. One embodiment of the invention may provide a format to be used to insure processing devises interpret the versions number correctly.

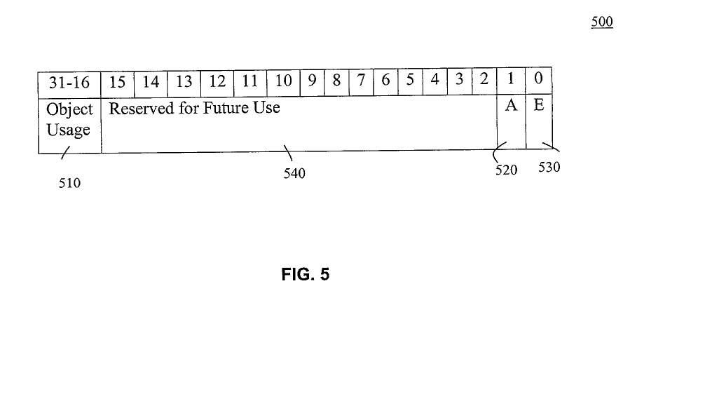

Another embodiment of the invention may provide at least one 16-bit word within the object header to include flags 500 (object flags) as illustrated in FIG. 5, which can help to control how the object is invoked. One word 510 of these flags may be reserved for use within the object and may be read by a member function of the class, CSystem. A further embodiment may provide a word consisting of an authentication bit 520, and an encryption bit 530, with the remaining bits 540 used for future enhancements of the invention.

If the encryption bit E 530 is set, the entire applet object and associated data objects may be encrypted in one embodiment by using Twofish, as is known in the art. Content providers may then have the burden of distributing encryption keys based on their requirements. In another embodiment, the content provided may provide the encryption key directly to a OEM for embedding within their product. For the embodiments embedding encryption keys within the device's firmware, or stored on a library in a PC, the secrecy of the location and method of archiving of encryption keys may need to be provided.

An additional embodiment of the invention may provide a means for authenticating an object prior to the objects use. That is to say, authentication enables the host to determine whether or not the object is legitimate, un-tampered, and from the owner that is suspected. The authentication bit 520 can be provided whether or not the applet objects and data objects are encrypted. Encryption alone, however, may not ensure authentication. An object can be authenticated as such if the authentication bit 520 is set.

In a further embodiment, authentication may be accomplished with RSA public key cryptography. For this embodiment, all processing devices may have a copy of the public component of a single master key. The holder of this master key is the Certification Authority (CA) and the master key is referred to as the CA Key. Only the CA has knowledge of the private component of the master key. Content providers who wish to use the authentication mechanism must also have a key. This key is presented to the CA in the form of an X.509 certificate signing request. The CA may then sign this certificate with the CA Key.

In an embodiment of an authenticated FMO stream, the content provider's X.509 certificate (signed by the CA Key) is present. The authenticity of the X.509 may be checked using the processing device copy of the public component of the CA Key. If it is not authentic, it may be ignored.

At the end of each authenticated applet object, a MD5 checksum (computed from both applet and data objects) may be generated by one embodiment, and signed by the content provider's key. To authenticate an object, the signature on the MD5 checksum may be verified using the content provider's public key (from the certificate), and the signed checksum can be compared to the signed checksum computed for the object. If the MD5 checksum does not match or the signature is invalid, the entire FMO file may be ignored.

The X.509 certificate length field in ID3 is optional. If the certificate is not included, the length should be set to zero. The X.509 certificate is a certificate for the public portion of an RSA 1024-bit key in extended X.509 format with a binary encoding. This certificate can be signed by the master key. If the certificate does not prove to be valid, it is ignored. Certificates may usually be less than 1 KBytes in length.

For an object, there are two types of functions. That is, functions that can have parameters passed to them and functions that can't. Member functions that cannot take parameters and do a specific task are called shortcuts. If a function can be defined as a shortcut, its function flag may be set to “1”. An object could be constructed using shortcuts or by using member functions, or a combination of both with the only significant difference being the amount of data embedded in the payload. In alternative embodiments, one technique may be more efficient than the others.

Functions, regardless of whether it is a member function or shortcut, can be defined in one of the following ways:

A single foundation class member function call (Release 1), Type 0 (0x00)

Multiple foundation class member function calls (Release 2), Type 1 (0x01)

Interpreted code (Release 3), Type 2 (0x02)

Machine dependent code (Release 4), Type 3 (0x03)

The number of member functions defined is specified by an 8-bit value, member function count (MFC). For functions of Type 0, each member function can be defined by the following parameters:

MFID: This is the identifier to be embedded within the media file bit stream. Maximally, it is 8-bits in length. However, the actual length (MFIDL) will be defined by the following equation:

MFIDL=RND(log₂(MFC))

Where RND( ) rounds the result up to the next integer.

FF: Function flags as discussed above.

FT: Function Type as discussed above.

CID: Identifier for the class of the member function.

FID: Function identifier of the function to be called.

Following the function identifier (FID), the number of parameters to be defined, NOPS, can be included. This number indicates how many parameters will be redefined to be different from the default values of the function. For each parameter, there may be a parameter index (PIDX) indicating which parameter of the function can be redefined followed by the parameter value (PV). The length of PV is determined by the function prototype. However, to simplify decoding, the minimum data chunk for the FMO file can be 8-bits. Therefore, if the parameter is 4-bits, then only the most significant nibble of the byte may be used. The rest will be ignored and should be filled with zeroes.

The MD5 Checksum should be computed for the entire applet object and the associated data objects but should not include the MD5 Checksum or the applet object flags. Each applet object shall have its own MD5 checksum so that an FMO file can be revised to change a single applet object and its associated data objects without affecting the remaining objects. A “RSA Signature” of the MD5 checksum may be required if a certificate is present, otherwise it should be omitted.

Many applications require the ability to pass data along with the object that can be accessed by member functions or shortcuts. Data definitions may be static and cannot be changed or may be defined as variables to allow modification at the applet's runtime. Typically, data objects can be handled differently depending on whether they are defined as read only or read/write. Variables that are defined as read only can be kept within the object and not moved elsewhere, saving memory.

There can be at most 256 data or variable objects within an object. The number of data objects defined within an object is determined by the data object count (DOC). Following the DOC, each data object is defined by the following parameters:

DOID: This is the unique 8-bit identifier of the data object.

DOF: Data object flags. These flags control how the host handles objects.

DOT: Data Object type. This determines the type of the data object is.

DOL: Number of elements in the data object. All variables can be thought of as arrays.

All of the elements in the data object may be defined. The length of a data element is defined by the DCT. However, to simply object interpreting, the minimum data size may be kept at 8-bits. If a data element is only one bit, the seven least significant bits can be ignored and should be zero.

The above-described methods and implementation of encoding and decoding media sequences are example methods and implementations. These methods and implementations illustrate one possible approach for encoding and decoding media sequences. The actual implementation may vary from the method discussed. Moreover, various other improvements and modifications to this invention may occur to those skilled in the art, and those improvements and modifications will fall within the scope of this invention as set forth below.

The present invention may be embodied in other specific forms without departing from its spirit or essential characteristics. The described embodiments are to be considered in all respects only as illustrative and not restrictive.

We claim:

1. A method for encoding a media sequence comprising:
providing at least one applet object;
inserting the applet object into at least one FMO file;
providing a media sequence including at least one media file;
integrating the FMO file into the media file; and
inserting at least one synchronous bit into the media file.

2. The method of claim 1, wherein the media file includes at least one media frame, inserting the synchronous bit into the media frame.

3. The method of claim 2, wherein the media frame includes an ancillary field, inserting the synchronous bit into the ancillary field.

4. The method of claim 1, wherein the media sequence is provided in a format selected from the group of formats consisting of MPEG 1/2 Layer 1/2, AC-3, WMA, AAC, EPAC, Liquid, ID3 and G-2 formats.

5. The method of claim 1, wherein the at least one FMO file includes a library of applet that can be loaded and paired with a media file.

6. The method of claim 1, further comprising: placing the at least one FMO file at the beginning of the media file.

7. The method of claim 1, further comprising: transferring the encoded media sequence to a device medium.

8. The method of claim 1, further comprising: providing at least one data object; and inserting the data object into the FMO file.

9. The method of claim 8, wherein the at least one FMO file includes a library of data objects that can be loaded and paired with a media file.

10. The method of claim 1, further comprising: providing a system interface for the applet object.

11. The method of claim 1, further comprising: providing a attribute file containing the functional definition of the applet object; and affixing the attribute file with the media sequence.

12. The method of claim 1, further comprising: encapsulating the FMO file within the media file; and concatenating the attribute file at the end of the media file.

13. The method of claim 1, further comprising: assigning an object identifier to all of the applet objects; and tracking each object identifier.

14. The method of claim 13, further comprising: assigning the object identifier from a specified agency.

15. The method of claim 1, further comprising: creating a MP3K file as a function of the synchronous bit media file and the media file.

16. The method of claim 1, further comprising: encrypting the applet object.

17. The method of claim 1, further comprising: authenticating the applet object.

18. A system for encoding a media sequence comprising:
means for providing at least one applet object;
means for inserting the applet object into at least one FMO file;
means for providing a media sequence including at least one media file;
means for integrating the FMO file into the media file; and
means for inserting at least one synchronous bit into the media file.

19. The system of claim 18, further comprising: means for transferring the encoded media sequence to a device medium.

20. The system of claim 18, further comprising: means for assigning an object identifier to all of the applet objects; and means for tracking each object identifier.

21. A computer usable medium storing a computer program comprising:
computer readable code for providing at least one applet object;
computer readable code for inserting the applet object into at least one FMO file;
computer readable code for providing a media sequence including at least one media file;
computer readable code for integrating the FMO file into the media file; and
computer readable code for inserting at least one synchronous bit into the media file.

22. The computer usable medium of claim 21, further comprising: computer readable code for transferring the encoded media sequence to a device medium.

23. The computer usable medium of claim 21, further comprising: computer readable code for assigning an object identifier to all of the applet objects; and computer readable code for tracking each object identifier.

24. A method for decoding a media sequence comprising:
receiving an encoded media sequence;
retrieving at least one media file from the media sequence;
retrieving at least one applet object from within the media file; and
processing the applet object and the media file synchronously.

25. The method of claim 24 further comprising: retrieving at least one MP3K file within the encoded media sequence; retrieving at least one media frame within the MP3K file; and retrieving at least one FMO file from within the media frame.

26. The method of claim 25, further comprising: providing the functionality for the applet object from the FMO file.

27. The method of claim 24 further comprising: interpreting the processed applet object and the media file by use of a processing device.

28. The method of claim 24, further comprising: retrieving an attribute file from the encoded media sequence; and providing the functionality for the applet object from the attribute file.

29. The method of claim 24, further comprising: providing a system interface for the applet object.

30. The method of claim 24, further comprising: decrypting the at least one applet object.

31. The method of claim 24, further comprising: authenticating the at least one applet object.

32. The method of claim 24, wherein the encoded media sequence is provided in a format selected from the group of formats consisting of MPEG 1/2 Layer 1/2, AC-3, WMA, AAC, EPAC, Liquid, ID3 and G-2 formats.

33. A system for decoding a media sequence comprising:
means for receiving an encoded media sequence;
means for retrieving at least one media file from the media sequence;
means for retrieving at least one applet object from within the media file; and
means for processing the applet object and the media file synchronously.

34. The system of claim 33 further comprising: means for retrieving at least one MP3K file within the encoded media sequence; means for retrieving at least one media frame within the MP3K file; and means for retrieving at least one FMO file from within the media frame.

35. The system of claim 34, further comprising: means for providing the functionality for the at least one applet object from the at least one FMO file.

36. The system of claim 33, further comprising: means for retrieving an attribute file from the encoded media sequence; and means for providing the functionality for the applet object from the attribute file.

37. The system of claim 33, further comprising: means for providing a system interface for the applet object.

38. The system of claim 33, further comprising: means for decrypting the applet object.

39. The system of claim 28, further comprising: means for authenticating the applet object.

40. A computer usable medium storing a computer program comprising:
computer readable code for receiving an encoded media sequence;
computer readable code for retrieving at least one media file from the media sequence;
computer readable code for retrieving at least one applet object from within the media file; and
computer readable code for processing the applet object and the media file synchronously.

41. The computer usable medium of claim 40, further comprising: computer readable code for retrieving an attribute file from the encoded media sequence; and computer readable code for providing the functionality for the applet object from the attribute file.

42. The computer usable medium of claim 40, further comprising: computer readable code for providing a system interface for the applet.

43. The computer usable medium of claim 40, further comprising: computer readable code for decrypting the applet object.

44. The computer usable medium of claim 40, further comprising: computer readable code for authenticating the applet object.
